(19) United States
(12) Patent Application Publication
(10) Pub. No.: US 2024/0401820 A1
(43) Pub. Date: Dec. 5, 2024

(54) AIR CONDITIONER

(71) Applicant: SAMSUNG ELECTRONICS CO., LTD., Suwon-si (KR)

(72) Inventors: Seonuk NA, Suwon-si (KR); Kyunghoon Kim, Suwon-si (KR); Sunggoo Kim, Suwon-si (KR); Hyunah Kim, Suwon-si (KR); Hyeongjoon Seo, Suwon-si (KR); Kisup Lee, Suwon-si (KR)

(73) Assignee: SAMSUNG ELECTRONICS CO., LTD., Suwon-si (KR)

(21) Appl. No.: 18/635,643

(22) Filed: Apr. 15, 2024

Related U.S. Application Data
(63) Continuation of application No. PCT/KR2024/003709, filed on Mar. 25, 2024.

(30) Foreign Application Priority Data
Jun. 2, 2023 (KR) 10-2023-0071940

(51) Int. Cl. F24F 1/028; F24F 7/013; F24F 11/00; F24F 11/77; F24F 12/00; F24F 110/40

(52) U.S. Cl. CPC F24F 1/028; F24F 7/013; F24F 11/0001; F24F 11/77; F24F 12/003; F24F 2110/40

(57) ABSTRACT

An air conditioner includes: a housing, an indoor air inlet configured to draw in indoor air, and an outlet to discharge air introduced into the outdoor air inlet and the indoor air inlet; a blower fan to generate an air flow; a total heat exchanger in the housing and to exchange heat; a compressor in the housing and to compress a refrigerant; a condenser to condense the refrigerant as compressed by the compressor; an expansion device to expand the refrigerant as condensed in the condenser; and an evaporator to evaporate the refrigerant as discharged from the expansion device, wherein the outlet includes: a first outlet to discharge the outdoor air, which passes through the total heat exchanger and the evaporator, into an indoors; and a second outlet to discharge the indoor air, which passes through the condenser, to the outdoors.

### CROSS-REFERENCE TO RELATED APPLICATIONS

This application is a continuation of International Application No. PCT/KR2024/003709, filed on Mar. 25, 2024, which claims priority to Korean Application No. 10-2023-0071940, filed on Jun. 2, 2023, in the Korean Intellectual Property Office, the disclosures of which are incorporated by reference herein in their entireties.

### BACKGROUND

### 1. Field

The disclosure relates to an air conditioner.

### 2. Description of Related Art

An air conditioner uses a refrigerant cycle to control temperature, humidity, airflow, and distribution of air to be appropriate for human activities, while also removing foreign substances such as dust in the air. Main components that form the refrigerant cycle include a compressor, a condenser, an evaporator, and a blower fan.

The air conditioner may be classified as a separate type in which an indoor unit and an outdoor unit are separately installed, and an integrated type in which both the indoor unit and the outdoor unit are installed in a single housing.

As for the integrated air conditioner, a portion corresponding to the indoor unit may be installed to face the indoors and a portion corresponding to the outdoor unit may be installed to face the outdoors with a wall or a window interposed therebetween.

### SUMMARY

Provided is an air conditioner capable of performing a ventilation function.

Further, provided is an air conditioner capable of performing air humidity and temperature control functions.

Further, provided is an air conditioner with increased space utilization.

Further, provided is an air conditioner with increased energy efficiency.

According to an aspect of the disclosure, there is an air conditioner including: a housing, including an outdoor air inlet configured to draw in outdoor air, an indoor air inlet configured to draw in indoor air, and an outlet configured to discharge air introduced into the outdoor air inlet and the indoor air inlet; a blower fan in the housing and configured to generate an air flow; a total heat exchanger in the housing and configured to exchange heat between the outdoor air, drawn through the outdoor air inlet, and the indoor air, drawn through the indoor air inlet; a compressor in the housing and configured to compress a refrigerant; a condenser configured to condense the refrigerant as compressed by the compressor; an expansion device configured to expand the refrigerant as condensed in the condenser; and an evaporator configured to evaporate the refrigerant as discharged from the expansion device, wherein the outlet includes: a first outlet configured to discharge the outdoor air, which passes through the total heat exchanger and the evaporator, into an indoors; and a second outlet configured to discharge the indoor air, which passes through the condenser, to the outdoors.

The outdoor air inlet may include: an outdoor air ventilation inlet configured to pass the outdoor air into an outdoor air ventilation flow path discharged to the first outlet; and an outdoor air circulation inlet configured to pass the outdoor into an outdoor air circulation flow path discharged to the second outlet, and the outdoor air circulation inlet may be spaced apart from the outdoor air ventilation inlet.

The outdoor air ventilation flow path may include a first space, formed upstream of the total heat exchanger, and a second space, formed downstream of the total heat exchanger, the outdoor air ventilation inlet may include: a first outdoor air ventilation inlet configured to draw in the outdoor air into the first space; and a second outdoor air ventilation inlet configured to draw in the outdoor air into the second space.

The air conditioner may also include: a first outdoor air ventilation inlet damper configured to open and close the first outdoor air ventilation inlet; and a second outdoor air ventilation inlet damper configured to open and close the second outdoor air ventilation inlet.

The blower fan may include: a first blower fan configured to generate an air flow to discharge the outdoor air, which is drawn into the outdoor air ventilation inlet, to the first outlet; and a second blower fan configured to generate an air flow to discharge the outdoor air, which is drawn into the outdoor air circulation inlet, to the second outlet.

The outlet may further include a third outlet configured to discharge the indoor air, which is drawn into the indoor air inlet and passes through the total heat exchanger, to the outdoors.

The indoor air inlet may include: an indoor air circulation inlet configured to pass the indoor air into an indoor air circulation flow path discharged to the first outlet; and an indoor air ventilation inlet configured to pass the indoor air into an indoor air ventilation flow path discharged to the third outlet, and the indoor air ventilation inlet is spaced apart from the indoor air circulation inlet.

The blower fan may further include: a third blower fan configured to generate an air flow to discharge the indoor air, which is drawn into the indoor air ventilation inlet, to the third outlet.

The air conditioner may further include an indoor air circulation inlet damper configured to open and close the indoor air circulation inlet; and an indoor air ventilation inlet damper configured to open and close the indoor air ventilation inlet.

The air conditioner may further include: a differential pressure sensor configured to measure an outdoor air pressure and an indoor air pressure; and a processor electrically connected to the differential pressure sensor, the first outdoor air ventilation inlet damper, the indoor air ventilation inlet damper, the first blower fan, and the third blower fan.

The processor may be configured to obtain information related to the outdoor air pressure and the indoor air pressure from the differential pressure sensor, and based on the outdoor air pressure being greater than the indoor air pressure, control the first outdoor air ventilation inlet damper to close at least a portion of the first outdoor air ventilation inlet and control the third blower fan to increase a rotation speed thereof.

The processor may be configured to obtain information of the outdoor air pressure and the indoor air pressure from the differential pressure sensor, and based on the indoor air pressure being greater than the outdoor air pressure, control the indoor air ventilation inlet damper to close at least a portion of the indoor air ventilation inlet and control the first blower fan to increase a rotation speed thereof.

The housing may include an upper housing and a lower housing removably coupled to the upper housing, and the compressor, the condenser, the expansion device, and the evaporator may be disposed in the lower housing.

The total heat exchanger may be in the upper housing.

The air conditioner may further include a partition disposed between the first outlet and the second outlet and configured to prevent mixing of air in the housing.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view illustrating an air conditioner according to one or more embodiments of the present disclosure;

FIG. 2 is a perspective view illustrating the air conditioner according to one or more embodiments of the present disclosure;

FIG. 3 is an exploded view of a configuration of the air conditioner according to one or more embodiments of the present disclosure;

FIG. 4 is a cross-sectional view of the air conditioner according to one or more embodiments of the present disclosure;

FIG. 5 is an enlarged cross-sectional view of the air conditioner according to one or more embodiments of the present disclosure;

FIG. 6 is a view schematically illustrating an air flow of the air conditioner according to one or more embodiments of the present disclosure;

FIG. 7 is a view schematically illustrating an air flow of the air conditioner according to one or more embodiments of the present disclosure;

FIG. 8 is a view schematically illustrating an air flow of the air conditioner according to one or more embodiments of the present disclosure;

FIG. 9 is a view schematically illustrating an air flow of the air conditioner according to one or more embodiments of the present disclosure;

FIG. 10 is a perspective view illustrating a state in which the air conditioner according to one or more embodiments of the present disclosure is divided;

FIG. 11 is a view illustrating a state in which the air conditioner according to one or more embodiments of the present disclosure is installed; and

FIG. 12 is a view illustrating a state in which the air conditioner according to one or more embodiments of the present disclosure is installed.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The terms “A or B,” “at least one of A or B,” “at least one of A and B,” or “one or more of A or/and B,” “A, B or C,” “at least one of A, B or/and C,” or “one or more of A, B or/and C,” and the like used herein may include any and all combinations of one or more of the associated listed items.

The terms of “and/or” and “or/and” each include a plurality of combinations of relevant items or any one item among a plurality of relevant items.

The term “part”, “module”, or “component” may be implemented in hardware or software. In some embodiments, a plurality of “parts”, “modules”, and “components” may be implemented as a single component, or a single “part”, “module”, or “component” may comprise multiple components.

Herein, the expressions “a first”, “a second”, “the first”, “the second”, etc., may simply be used to distinguish an element from other elements, but is not limited to another aspect (e.g., importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

An air conditioner according to various embodiments is a device that performs functions such as purification, ventilation, humidity control, cooling or heating in an air conditioning space (hereinafter referred to as “indoor space”), and particularly a device having at least one of these functions.

According to an embodiment, an air conditioner may include a heat pump device to perform a cooling function or a heating function. The heat pump device may include a refrigeration cycle in which a refrigerant is circulated through a compressor, a first heat exchanger, and an expansion device and a second heat exchanger. All components of the heat pump device may be embedded in one housing forming an exterior of an air conditioner, which includes a window-type air conditioner or a portable air conditioner. On the other hand, some components of the heat pump device may be divided and embedded in a plurality of housings forming a single air conditioner, which includes a wall-mounted air conditioner, a stand-type air conditioner, and a system air conditioner.

The air conditioner including the plurality of housings may include at least one outdoor unit installed outdoors and at least one indoor unit installed indoors. For example, the air conditioner may be provided in such a way that a single outdoor unit and a single indoor unit are connected through a refrigerant pipe. Alternatively, the air conditioner may be provided in such a way that a single outdoor unit is connected to two or more indoor units through a refrigerant pipe. Alternatively, the air conditioner may be provided in such a way that two or more outdoor units and two or more indoor units are connected through a plurality of refrigerant pipes.

The outdoor unit may be electrically connected to the indoor unit. For example, information (or commands) for controlling the air conditioner may be received through an input interface provided in the outdoor unit or the indoor unit. The outdoor unit and the indoor unit may operate simultaneously or sequentially in response to a user input.

The air conditioner may include an outdoor heat exchanger provided in the outdoor unit, an indoor heat exchanger provided in the indoor unit, and a refrigerant pipe connecting the outdoor heat exchanger and the indoor heat exchanger.

The outdoor heat exchanger may be configured to exchange heat between a refrigerant and outdoor air through a phase change of the refrigerant (e.g., evaporation or condensation). For example, while the refrigerant is condensed in the outdoor heat exchanger, the refrigerant may radiate heat to the outdoor air. While the refrigerant flowing in the outdoor heat exchanger evaporates, the refrigerant may absorb heat from the outdoor air.

The indoor unit is installed indoors. For example, according to the arrangement method of the indoor unit, the air conditioner may be classified into a ceiling-type indoor unit, a stand-type indoor unit, a wall-mounted indoor unit, and the like. For example, the ceiling-type indoor unit may be classified into a 4-way type indoor unit, a 1-way type indoor unit, a duct type indoor unit and the like according to a method of discharging air.

As mentioned above, the indoor heat exchanger may be configured to exchange heat between a refrigerant and outdoor air through a phase change of the refrigerant (e.g., evaporation or condensation). For example, while the refrigerant evaporates in the indoor unit, the refrigerant may absorb heat from the indoor air. The indoor space may be cooled by blowing the indoor air cooled through the cooled indoor heat exchanger. While the refrigerant is condensed in the indoor heat exchanger, the refrigerant may radiate heat to the indoor air. The indoor space may be heated by blowing the indoor air heated through the high-temperature indoor heat exchanger.

In other words, the air conditioner may perform a cooling or heating function through a phase change process of a refrigerant circulating between the outdoor heat exchanger and the indoor heat exchanger. To circulate the refrigerant, the air conditioner may include a compressor for compressing the refrigerant. The compressor may intake refrigerant gas through an inlet and compress the refrigerant gas. The compressor may discharge high-temperature and high-pressure refrigerant gas through an outlet. The compressor may be disposed inside the outdoor unit.

Through the refrigerant pipe, the refrigerant may be sequentially circulated through the compressor, the outdoor heat exchanger, the expansion device, and the indoor heat exchanger or sequentially circulated through the compressor, the indoor heat exchanger, the expansion device, and the outdoor heat exchanger.

For example, in the air conditioner, when a single outdoor unit and a single indoor unit are directly connected through a refrigerant pipe, the refrigerant may be circulated between the single outdoor unit and the single indoor unit through the refrigerant pipe.

For example, in the air conditioner, when a single outdoor unit is connected to two or more indoor units through a refrigerant pipe, the refrigerant may flow from the single outdoor unit to the plurality of indoor units through branched refrigerant pipes. Refrigerants discharged from the plurality of indoor units may be combined and circulated to the outdoor unit. For example, through a separate refrigerant pipe, each of the plurality of indoor units may be directly connected in parallel to the single outdoor unit.

Each of the plurality of indoor units may be operated independently according to an operation mode set by a user. In other words, some of the plurality of indoor units may be operated in a cooling mode while others of the plurality of indoor units is operated in a heating mode. At this time, the refrigerant may be selectively introduced into each indoor unit in a high-pressure state or a low-pressure state, discharged, and circulated to the outdoor unit along a circulation path that is designated through a flow path switching valve to be described later.

For example, in the air conditioner, when two or more outdoor units and two or more indoor units are connected through the plurality of refrigerant pipes, refrigerants discharged from the plurality of outdoor units may be combined and flow through one refrigerant pipe, and then diverged again at a certain point and introduced into the plurality of indoor units.

All of the plurality of outdoor units may be driven or at least some of the plurality of outdoor units may not be driven according to a driving load according to an operation amount of the plurality of indoor units. At this time, through a flow path switching valve, the refrigerant may be provided to be introduced into and circulated to an outdoor unit that is selectively driven. The air conditioner may include the expansion device to lower the pressure of the refrigerant flowing into the heat exchanger. For example, the expansion device may be disposed inside the indoor unit or inside the outdoor unit, or disposed inside the indoor unit and the outdoor unit.

The expansion device may lower a temperature and pressure of the refrigerant by using a throttling effect. The expansion device may include an orifice configured to reduce a cross-sectional area of a flow path. A temperature and pressure of the refrigerant passing through the orifice may be lowered.

For example, the expansion device may be implemented as an electronic expansion valve configured to adjust an opening ratio (a ratio of a cross-sectional area of a flow path of a valve in a partially opened state to a cross-sectional area of the flow path of the valve in a fully open state). According to the opening ratio of the electronic expansion valve, the amount of refrigerant passing through the expansion device may be adjusted.

The air conditioner may further include a flow path switching valve disposed on the refrigerant circulation path. The flow path switching valve may include a 4-way valve. The flow path switching valve may determine a refrigerant circulation path depending on an operation mode of the indoor unit (e.g., cooling operation or heating operation). The flow path switching valve may be connected to the outlet of the compressor.

The air conditioner may include an accumulator. The accumulator may be connected to the inlet of the compressor. A low-temperature and low-pressure refrigerant, which is evaporated in the indoor heat exchanger or the outdoor heat exchanger, may flow into the accumulator.

When a refrigerant mixture of refrigerant liquid and refrigerant gas is introduced, the accumulator may separate the refrigerant liquid from the refrigerant gas, and supply the refrigerant gas, from which the refrigerant liquid is separated, to the compressor.

An outdoor fan may be provided near the outdoor heat exchanger. The outdoor fan may blow outdoor air to the outdoor heat exchanger to promote heat exchange between the refrigerant and the outdoor air.

The outdoor unit of the air conditioner may include at least one sensor (hereinafter referred to as an outdoor unit sensor). For example, the sensor of the outdoor unit may be provided as an environment sensor. The outdoor unit sensor may be disposed at a certain position of the inside or the outside of the outdoor unit. For example, the outdoor unit sensor may include a temperature sensor configured to detect an air temperature around the outdoor unit, a humidity sensor configured to detect air humidity around the outdoor unit, or a refrigerant temperature sensor configured to detect a refrigerant temperature in a refrigerant pipe passing through the outdoor unit, or a refrigerant pressure sensor configured to detect a refrigerant pressure in a refrigerant pipe passing through the outdoor unit.

The outdoor unit of the air conditioner may include an outdoor unit communication circuitry. The outdoor unit communication circuitry may be configured to receive a control signal from an indoor unit controller of the air conditioner, which will be described later. Based on a control signal received through the outdoor unit communication circuitry, the outdoor unit may control the operation of the compressor, the outdoor heat exchanger, the expansion device, the flow path switching valve, the accumulator, or the outdoor fan. The outdoor unit may transmit a sensing value detected by the outdoor unit sensor to the indoor unit controller through the outdoor unit communication circuitry.

The outdoor unit communication circuitry may include at least one of a short-range communication module or a long-range communication module.

The indoor unit of the air conditioner may include a housing, a blower configured to circulate air inside or outside the housing, and the indoor heat exchanger configured to exchange heat with air introduced into the housing.

The housing may include an inlet. Indoor air may flow into the housing through the inlet.

The indoor unit of the air conditioner may include a filter provided to filter out foreign substance in air that is introduced into the inside of the housing through the inlet.

The housing may include an outlet. Air flowing inside the housing may be discharged to the outside of the housing through the outlet.

An airflow guide configured to guide a direction of air discharged through the outlet may be provided in the housing of the indoor unit. For example, the airflow guide may include a blade positioned in the outlet. For example, the airflow guide may include an auxiliary fan for regulating an exhaust airflow, but is not limited thereto. Alternatively, the airflow guide may be omitted.

The indoor heat exchanger and the blower arranged on a flow path connecting the inlet and the outlet may be disposed inside the housing of the indoor unit.

The blower may include an indoor fan and a fan motor. For example, the indoor fan may include an axial fan, a mixed flow fan, a crossflow fan and a centrifugal fan.

The indoor heat exchanger may be arranged between the blower and the outlet or between the inlet and the blower. The indoor heat exchanger may absorb heat from air introduced through the inlet or transfer heat to air introduced through the inlet. The indoor heat exchanger may include a heat exchange tube through which a refrigerant flows, and a heat exchanger fin in contact with the heat exchange tube to increase a heat transfer area.

The indoor unit of the air conditioner may include a drain tray disposed below the indoor heat exchanger to collect condensed water generated in the indoor heat exchanger. The condensed water contained in the drain tray may be drained to the outside through a drain hose. The drain tray may be provided to support the indoor heat exchanger.

The indoor unit of the air conditioner may include an input interface. The input interface may include any type of user input means including a button, a switch, a touch screen and/or a touch pad. A user can directly input setting data (e.g., desired indoor temperature, cooling/heating/dehumidifying/air cleaning operation mode setting, outlet selection setting, and/or air volume setting) through the input interface.

The input interface may be connected to an external input device. For example, the input interface may be electrically connected to a wired remote controller. The wired remote controller may be installed at a specific location (e.g., a part of a wall) in an indoor space. A user can input setting data related to the operation of the air conditioner by manipulating the wired remote controller. An electrical signal corresponding to the setting data obtained through the wired remote controller may be transmitted to the input interface. Further, the input interface may include an infrared sensor. A user can remotely input the setting data for the operation of the air conditioner by using a wireless remote controller. The setting data received through the wireless remote controller may be transmitted to the input interface as an infrared signal.

Further, the input interface may include a microphone. A user's voice command may be obtained through the microphone. The microphone may convert a user's voice command into an electrical signal and transmit the electrical signal to the indoor unit controller. The indoor unit controller may control components of the air conditioner to execute a function corresponding to the user's voice command. The setting data obtained through the input interface (e.g., desired indoor temperature, cooling/heating/dehumidifying/air cleaning operation mode setting, outlet selection setting, and/or air volume setting) may be transmitted to the indoor unit controller to be described later. For example, the setting data obtained through the input interface may be transmitted to the outside, that is, to the outdoor unit or a server through an indoor unit communication circuitry to be described later.

The indoor unit of the air conditioner may include a power module. The power module may be connected to an external power source to supply power to components of the indoor unit.

The indoor unit of the air conditioner may include an indoor unit sensor. The indoor unit sensor may be an environment sensor disposed inside or outside the housing. For example, the indoor unit sensor may include one or more temperature sensors and/or humidity sensors disposed in a predetermined space inside or outside the housing of the indoor unit. For example, the indoor unit sensor may include a refrigerant temperature sensor configured to detect a refrigerant temperature of a refrigerant pipe passing through the indoor unit. For example, the indoor unit sensor may include a refrigerant temperature sensor configured to detect a temperature of an entrance, a middle portion and/or an exit of the refrigerant pipe passing through the indoor heat exchanger.

For example, each environmental information detected by the indoor unit sensor may be transmitted to the indoor unit controller to be described later or transmitted to the outside through the indoor unit communication circuitry to be described later.

The indoor unit of the air conditioner may include the indoor unit communication circuitry. The indoor unit communication circuitry may include at least one of a short-range wireless communication module and a long-range wireless communication module. The indoor unit communication circuitry may include at least one antenna for wirelessly communicating with other devices. The outdoor unit may include the outdoor unit communication circuitry. The outdoor unit communication circuitry may also include at least one of a short-range wireless communication module and a long-range wireless communication module.

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server on a mobile communication network.

The indoor unit communication circuitry may communicate with an external device such as a server, a mobile device and other home appliances through an access point (AP). The access point (AP) may connect a local area network (LAN), to which an air conditioner or a user device is connected, to a wide area network (WAN) to which a server is connected. The air conditioner or the user device may be connected to the server through the wide area network (WAN). The indoor unit of the air conditioner may include the indoor unit controller configured to control components of the indoor unit including the blower. The outdoor unit of the air conditioner may include an outdoor unit controller configured to control components of the outdoor unit including the compressor. The indoor unit controller may communicate with the outdoor unit controller through the indoor unit communication circuitry and the outdoor unit communication circuitry. The outdoor unit communication circuitry may transmit a control signal generated by the outdoor unit controller to the indoor unit communication circuitry, or transmit a control signal, which is transmitted from the indoor unit communication circuitry, to the outdoor unit controller. In other words, the outdoor unit and the indoor unit may perform bi-directional communication. The outdoor unit and the indoor unit may transmit and receive various signals generated during operation of the air conditioner.

The outdoor unit controller may be electrically connected to components of the outdoor unit and may control operations of each component. For example, the outdoor unit controller may adjust a frequency of the compressor and control the flow path switching valve to change a circulation direction of the refrigerant. The outdoor unit controller may adjust a rotational speed of the outdoor fan. Further, the outdoor unit controller may generate a control signal for adjusting the opening degree of the expansion valve. Under the control of the outdoor unit controller, the refrigerant may be circulated along the refrigerant circulation circuit including the compressor, the flow path switching valve, the outdoor heat exchanger, the expansion valve, and the indoor heat exchanger.

Various temperature sensors included in the outdoor unit and the indoor unit may transmit electrical signals corresponding to detected temperatures to the outdoor unit controller and/or the indoor unit controller. For example, the humidity sensors included in the outdoor unit and the indoor unit may respectively transmit electrical signals corresponding to the detected humidity to the outdoor unit controller and/or the indoor unit controller.

The indoor unit controller may obtain a user input from a user device including a mobile device through the indoor unit communication circuitry, or directly obtain a user input through the input interface or the remote controller. The indoor unit controller may control components of the indoor unit including the blower in response to the received user input. The indoor unit controller may transmit information related to the received user input to the outdoor unit controller of the outdoor unit.

The outdoor unit controller may control components of the outdoor unit including the compressor based on the information related to the user input received from the indoor unit. For example, when a control signal corresponding to a user input for selecting an operation mode such as a cooling operation, a heating operation, a fan operation, a defrosting operation, or a dehumidifying operation is received from the indoor unit, the outdoor unit controller may control components of the outdoor unit to perform an operation of the air conditioner corresponding to the selected operation mode.

The outdoor unit controller and indoor unit controller may include a processor and a memory, respectively. The indoor unit controller may include at least one first processor and at least one first memory, and the outdoor unit controller may include at least one second processor and at least one second memory.

The memory may memorize/store various types of information necessary for the operation of the air conditioner. The memory may store instructions, applications, data and/or programs necessary for the operation of the air conditioner. For example, the memory may store various programs for the cooling operation, the heating operation, the dehumidifying operation, and/or the defrosting operation of the air conditioner. The memory may include volatile memory such as a static random access memory (S-RAM) and a dynamic random access memory (D-RAM) for temporarily storing data. In addition, the memory may include a non-volatile memory such as a read only memory (ROM), an erasable programmable read only memory (EPROM), and an electrically erasable programmable read only memory (EEPROM) for long-term storage of data.

The processor may generate a control signal for controlling an operation of the air conditioner based on instructions, applications, data, and/or programs stored in the memory. The processor may be hardware and may include a logic circuit and an arithmetic circuit. The processor may process data according to a program and/or instructions provided from the memory, and may generate a control signal according to a processing result. The memory and the processor may be implemented as one control circuit or as a plurality of circuits.

The indoor unit of the air conditioner may include an output interface. The output interface may be electrically connected to the indoor unit controller, and output information related to the operation of the air conditioner under the control of the indoor unit controller. For example, the output interface may output information such as an operation mode selected by a user input, a wind direction, a wind volume, and a temperature. Further, the output interface may output sensing information obtained from the indoor unit sensor or the outdoor unit sensor, and output warning/error messages.

The output interfaces may include a display and a speaker. The speaker may be a sound device and configured to output various sounds. The display may display information, which is input by a user or provided to a user, as various graphic elements. For example, operation information of the air conditioner may be displayed as at least one of an image and text. Further, the display may include an indicator providing specific information. The display may include a liquid crystal display (LCD) panel, a light emitting diode (LED) panel, an organic light emitting diode (OLED) panel, a micro-LED panel, and/or a plurality of LEDs.

Hereinafter, example embodiments of an air conditioner will be described in detail with reference to the accompanying drawings.

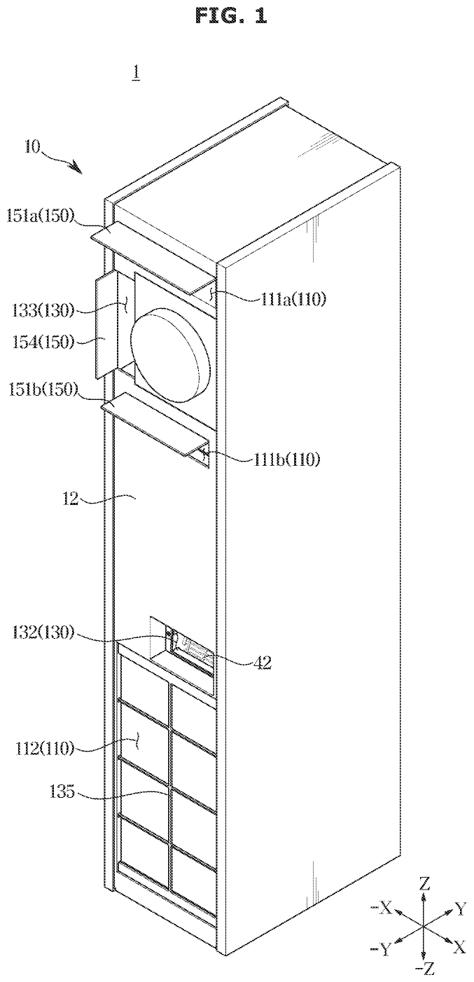

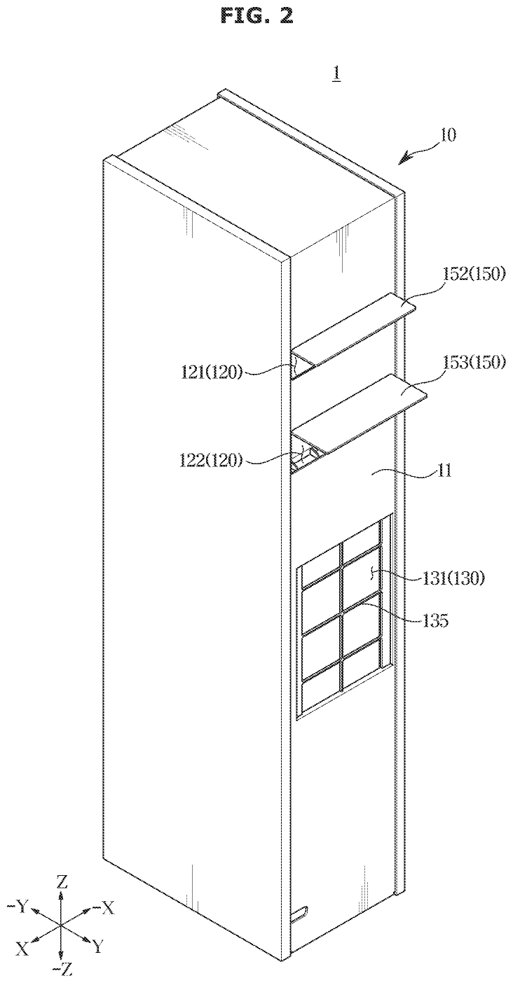

FIG. 1 is a perspective view illustrating an air conditioner 1 according to one or more embodiments of the present disclosure. FIG. 2 is a perspective view illustrating the air conditioner 1 according to one or more embodiments of the present disclosure.

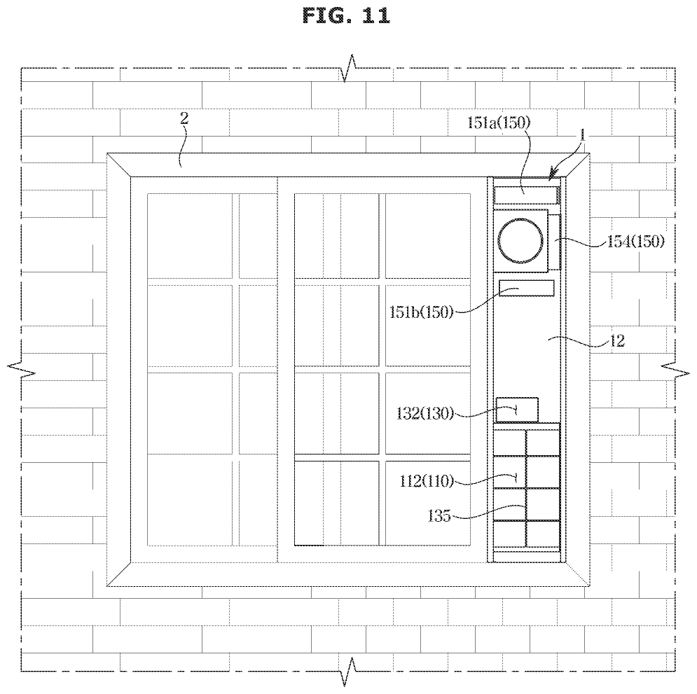

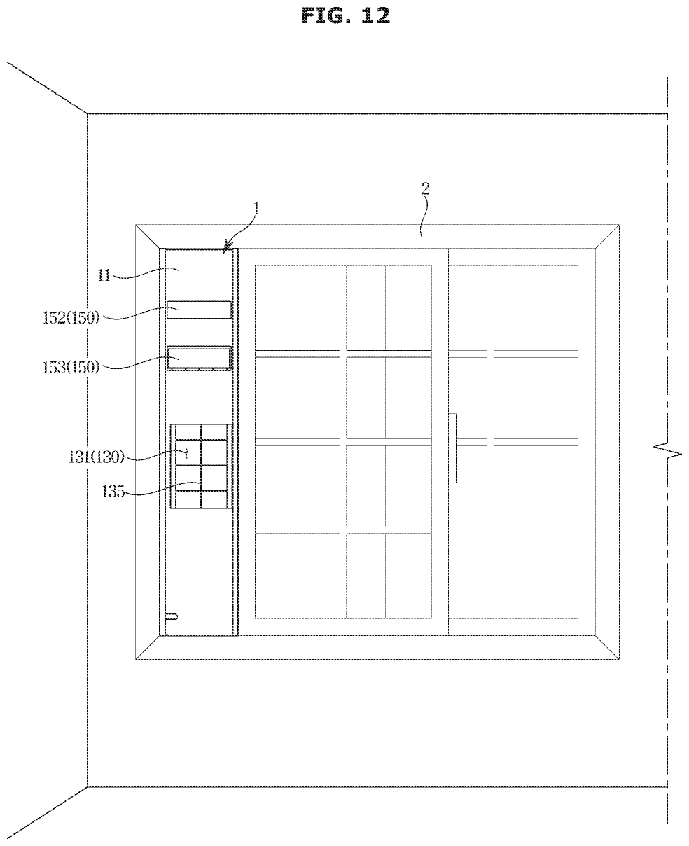

With respect to a window 2 on which an air conditioner 1 is installed (e.g., refer to FIG. 11 and FIG. 12), a direction facing the indoors may be defined as the front, and a direction facing the outdoors may be defined as the rear. In the drawing, +Y-axis direction may be defined as the front and −Y-axis direction may be defined as the rear.

The air conditioner 1 may include a housing 10 provided to form an exterior. The housing 10 may be installed on the window. The housing 10 may have a substantially box shape. The housing 10 may include a receiving space provided to accommodate components therein.

The housing 10 may include a front cover 11 and a rear cover 12. The front cover 11 may correspond to a surface arranged to face the indoors. The front cover 11 may form a front surface of the housing 10.

The rear cover 12 may correspond to a surface arranged to face the outdoors. The rear cover 12 may form a rear surface of the housing 10. The rear cover 12 may be arranged to face the front cover 11.

The air conditioner 1 may include housing inlet portions 110 and 120 provided to allow air to flow into the housing 10. The housing inlet portions 110 and 120 may be formed in the housing 10. The housing inlet portions 110 and 120 may be provided in the shape of a hole. The housing inlet portions 110 and 120 may be holes having a substantially square shape. However, the present disclosure is not limited thereto.

The housing inlet portions 110 and 120 may also be referred to as inlets 110 and 120. The inlets 110 and 120 may represent the housing inlet portions 110 and 120.

The housing inlet portions 110 and 120 may include an outdoor air inlet unit 110. The outdoor air inlet unit 110 may be provided to draw in outdoor air. Outdoor air may be drawn into the housing 10 through the outdoor air inlet unit 110.

The outdoor air inlet unit 110 may also be referred to as the outdoor air inlet 110. The outdoor air inlet 110 may represent the outdoor air inlet unit 110.

The outdoor air inlet unit, as the housing inlet portion 110, may include an outdoor air ventilation inlet 111. The outdoor air ventilation inlet 111 may be provided to allow outdoor air to flow into the indoors. Outdoor air may be drawn into the housing 10 through the outdoor air ventilation inlet 111 and then introduced into the indoors. The outdoor air ventilation inlet 111 may be provided to allow outdoor air to flow into the indoors and be ventilated.

The outdoor air ventilation inlet 111 may include a first outdoor air ventilation inlet 111a and a second outdoor air ventilation inlet 111b. The second outdoor air ventilation inlet 111b may be spaced apart from the first outdoor air ventilation inlet 111a. Outdoor air may be drawn into the housing 10 through the first outdoor air ventilation inlet 111a and/or the second outdoor air ventilation inlet 111b. A detailed description will be provided later.

The outdoor air inlet unit, as the housing inlet portion 110, may include an outdoor air circulation inlet 112. The outdoor air circulation inlet 112 may be provided to allow outdoor air to be circulated. Outdoor air may be drawn into the housing 10 through the outdoor air circulation inlet 112 and then discharged back to the outdoors. The outdoor air circulation inlet 112 may be provided to allow outdoor air to be circulated.

The housing inlet portions 110 and 120 may include an indoor air inlet unit 120. The indoor air inlet unit 120 may be provided to draw in indoor air. Indoor air may be drawn into the housing 10 through the indoor air inlet unit 120.

The indoor air inlet unit 120 may be referred to as the indoor air inlet 120. The indoor air inlet 120 may represent the indoor air inlet unit 120.

The indoor air inlet unit 120 may include an indoor air ventilation inlet 121. The indoor air ventilation inlet 121 may be provided to discharge indoor air to the outdoors. Indoor air may be drawn into the housing 10 through the indoor air ventilation inlet 121 and then discharged outdoors. The indoor air ventilation inlet 121 may be provided to allow indoor air to be discharged to the outdoors for ventilation.

The outdoor air ventilation inlet 111 may allow outdoor air to flow into the indoors, and the indoor air ventilation inlet 121 may discharge indoor air to the outdoors. The outdoor air ventilation inlet 111 and the indoor air ventilation inlet 121 may ventilate indoor and outdoor air.

The indoor air inlet unit, as the housing inlet portion 120, may include an indoor air circulation inlet 122. The indoor air circulation inlet 122 may be provided to allow indoor air to be circulated. Indoor air may be drawn into the housing 10 through the indoor air circulation inlet 122 and then discharged back into the indoors. The indoor air circulation inlet 122 may be provided to allow indoor air to be circulated.

The first outdoor air ventilation inlet 111a, the second outdoor air ventilation inlet 111b, and the outdoor air circulation inlet 112 may be formed in the rear cover 12. The indoor air ventilation inlet 121 and the indoor air circulation inlet 122 may be formed in the front cover 11.

The air conditioner 1 may include a housing outlet portion 130 provided to discharge air to the outside of the housing 10. The housing outlet portion 130 may be formed in the housing 10. The housing outlet portion 130 may be provided in the shape of a hole. The housing outlet portion 130 may have a substantially square shape. However, the present disclosure is not limited thereto.

The housing outlet portion 130 may be referred to as an outlet. The outlet may represent the housing outlet portion 130.

The housing outlet portion 130 may include a first outlet 131. The first outlet 131 may be provided to discharge air inside the housing 10 into the indoors. The first outlet 131 may be provided to discharge air, which is drawn through the outdoor air ventilation inlet 111, into the indoors. The first outlet 131 may be provided to discharge air, which is drawn into the indoor air circulation inlet 122, into the indoors.

The first outlet 131 may be placed indoors. The first outlet 131 may be open toward the indoors. The first outlet 131 may be provided to supply appropriate air to the indoors according to a mode selected by a user.

The first outlet 131 may be provided to discharge outdoor air to the indoors so as to ventilate air. The first outlet 131 may be provided to dehumidify and/or cool outdoor air and/or indoor air and discharge the dehumidified and/or cooled outdoor air and/or indoor air to the indoors. A detailed description will be provided later.

The housing outlet portion 130 may include a second outlet 132. The second outlet 132 may be provided to discharge the air inside the housing 10 to the outdoors. The second outlet 132 may be provided to discharge the air drawn through the outdoor air circulation inlet 112 to the outdoors.

The second outlet 132 may be placed outdoors. The second outlet 132 may be open toward the outdoors. The second outlet 132 may be arranged to face in a direction opposite to the first outlet 131.

The second outlet 132 may be provided to discharge outdoor air, which is drawn through the outdoor air circulation inlet 112, back to the outdoors so as to circulate the air. A detailed description will be provided later.

The housing outlet portion 130 may include a third outlet 133. The third outlet 133 may be provided to discharge the air inside the housing 10 to the outdoors. The third outlet 133 may be provided to discharge air, which is drawn through the indoor air ventilation inlet 121, to the outdoors.

The third outlet 133 may be placed outdoors. The third outlet 133 may be open toward the outdoors. The third outlet 133 may be arranged to face in a direction opposite to the first outlet 131. The third outlet 133 may be arranged to face the same direction as the second outlet 132.

The third outlet 133 may be provided to discharge indoor air, which is drawn through the indoor air ventilation inlet 121, to the outdoors so as to ventilate the air. The third outlet 133 may be provided to discharge indoor air to the outdoors. A detailed description will be provided later herein.

A grille 135 may be arranged at the first outlet 131 and/or the outdoor air circulation inlet 112. The grille 135 may have a grid shape. However, the present disclosure is not limited thereto.

The second outlet 132 and the third outlet 133 may be formed in the rear cover 12. The first outlet 131 may be formed in the front cover 11.

The air conditioner 1 may include a damper 150. The damper 150 may be configured to open and close the housing inlet portions 110 and 120 and/or the housing outlet portion 130.

The damper 150 may open the housing inlet portions 110 and 120 and/or the housing outlet portion 130. “Open” may represent completely opening the hall or partially opening at least a part of the hall.

The damper 150 may close the housing inlet portions 110 and 120 and/or the housing outlet portion 130. “Close” may represent completely closing the hall or partially closing at least a part of the hall. For example, this may mean completely sealing the hole or partially closing the hole to reduce an air flow rate passing through the housing inlet portions 110 and 120 and/or the housing outlet portion 130.

The damper 150 may be coupled to the housing 10. For example, the damper 150 may be hinged to the housing 10. The damper 150 may be provided to rotate to open and close the housing inlet portions 110 and 120 and/or the housing outlet portion 130. The damper 150 may have a plate shape. However, the present disclosure is not limited thereto, and the shape of the damper 150 may be implemented in various ways. For example, the damper 150 may be formed integrally with the housing 10.

The damper 150 may include a first outdoor air ventilation inlet damper 151a configured to open and close the first outdoor air ventilation inlet 111a, and a second outdoor air ventilation inlet damper 151b configured to open and close the second outdoor air ventilation inlet 111b.

The damper 150 may include a third outlet damper 154 configured to open and close the third outlet 133.

The damper 150 may include an indoor air ventilation inlet damper 152 configured to open and close the indoor air ventilation inlet 121, and an indoor air circulation inlet damper 153 configured to open and close the indoor air circulation inlet 122.

FIG. 1 and FIG. 2 illustrate that the damper 150 is in an open state, but the present disclosure is not limited thereto. The damper 150 may open or close each of the housing inlet portions 110 and 120 and the housing outlet portion 130 according to an operating mode of the air conditioner 1. This will be described later herein.

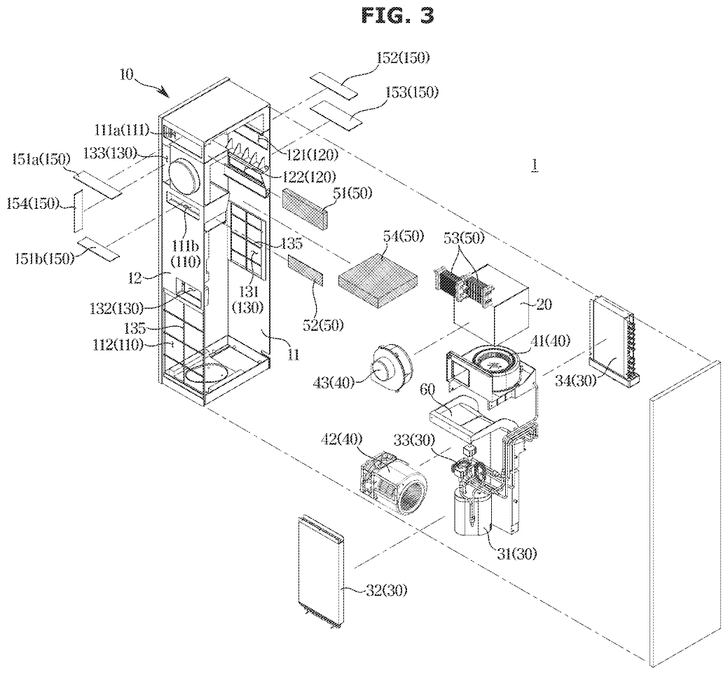

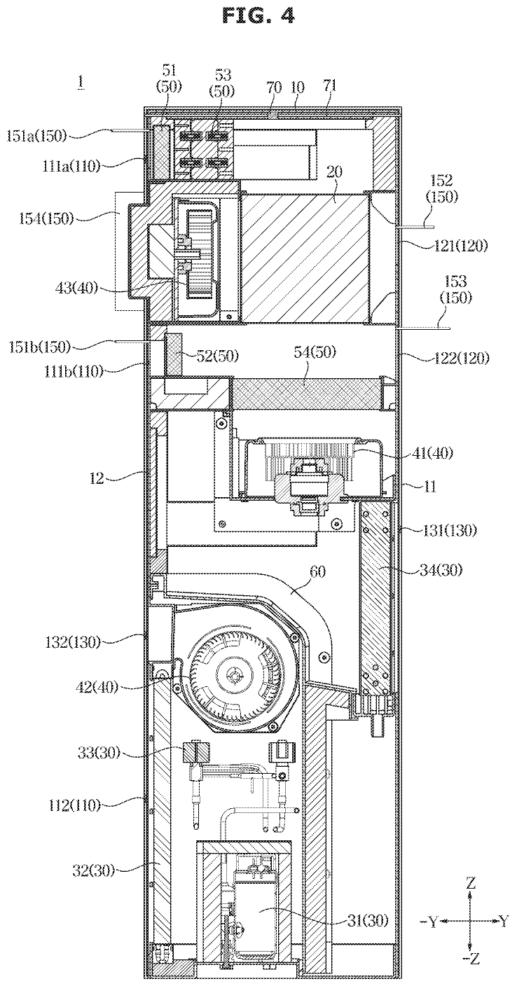

FIG. 3 is an exploded view of a configuration of the air conditioner according to one or more embodiments of the present disclosure. FIG. 4 is a cross-sectional view of the air conditioner according to one or more embodiments of the present disclosure.

The air conditioner 1 may include a total heat exchanger 20. The total heat exchanger 20 may be configured to exchange heat between outdoor air and indoor air.

When the air conditioner 1 operates in a total heat ventilation mode, outdoor air and indoor air may exchange heat with each other in the total heat exchanger 20. Outdoor air and indoor air may exchange heat with each other in the total heat exchanger 20 in a state in which the outdoor air and the indoor air are not in contact with each other.

The total heat exchanger 20 may be configured to exchange heat between outdoor air drawn into the first outdoor air ventilation inlet 111a and indoor air drawn into the indoor air ventilation inlet 121.

The total heat exchanger 20 may be disposed inside the housing 10. The total heat exchanger 20 may be disposed at a point at which the air drawn into the first outdoor air ventilation inlet 111a and the air drawn into the indoor air ventilation inlet 121 intersect.

The total heat exchanger 20 may be formed of paper coated with lithium chloride, and may also be referred to as a total heat exchange element. The total heat exchanger 20 may be implemented as a plate-type total heat exchanger or a rotary-type total heat exchanger.

The air conditioner 1 may include a heat pump device 30. The heat pump device 30 may be configured to control the humidity and/or temperature of the air. The heat pump device 30 may be disposed inside the housing 10.

The heat pump device 30 may be configured to control the humidity and/or temperature of the air discharged to the indoors by the air conditioner 1. The heat pump device 30 may be configured to adjust the humidity and/or temperature of the air discharged through the first outlet 131.

When the air conditioner 1 operates in a dehumidification mode and/or a temperature control mode, air may be heat exchanged in an evaporator 34 and/or a condenser 32, respectively.

The heat pump device 30 may include a compressor 31, the condenser 32, an expansion device 33, and the evaporator 34. The heat pump device 30 may be disposed inside the housing 10.

The compressor 31 may compress refrigerant gas to a high-temperature and high-pressure state and discharge the compressed refrigerant. The compressed refrigerant may be introduced into the condenser 32. The condenser 32 may condense the compressed refrigerant into a liquid phase and release heat to the surroundings through the condensation process. The expansion device 33 may expand the high-temperature and high-pressure liquid refrigerant condensed in the condenser 32 into the low-pressure liquid refrigerant. The evaporator 34 may evaporate the refrigerant expanded in the expansion device 33. The evaporator 34 may obtain a refrigeration effect by exchanging heat with air using the latent heat of evaporation of the refrigerant, and may return the low-temperature and low-pressure refrigerant gas to the compressor 31. Through the cycles, the humidity and/or temperature of the air may be adjusted.

The condenser 32 may also be referred to as an outdoor heat exchanger. The evaporator 34 may also be referred to as an indoor heat exchanger.

The evaporator 34 may be configured to control the humidity of the air discharged to the indoors. The evaporator 34 may remove moisture contained in the air passing through the evaporator 34. Because moisture contained in the air is removed as the air passes through the evaporator 34, dry air may be supplied to the indoor space.

The evaporator 34 may be configured to control the temperature of the air discharged to the indoors. The evaporator 34 may reduce the temperature by removing heat from the air passing through the evaporator 34. Because the temperature of the air decreases as the air passes through the evaporator 34, cool air may be supplied to the indoor space.

The evaporator 34 may be disposed adjacent to the first outlet 131, and the condenser 32 may be disposed adjacent to the outdoor air circulation inlet 112. A partition 60 may be disposed between the evaporator 34 and the condenser 32.

A blower fan 40 may be disposed inside the housing 10 to generate an air flow.

The blower fan 40 may include a first blower fan 41. The first blower fan 41 may also be referred to as a blower.

The first blower fan 41 may generate an air flow to allow outdoor air to be drawn into the outdoor air ventilation inlet 111 and to be discharged to the first outlet 131. The first blower fan 41 may generate an air flow to allow indoor air to be drawn into the indoor air ventilation inlet 121 and to be discharged to the second outlet 132. The first blower fan 41 may generate an air flow to allow indoor air to be drawn into the indoor air circulation inlet 122 and to be discharged to the second outlet 132.

The blower fan 40 may include a second blower fan 42. The second blower fan 42 may also be referred to as an outdoor fan.

The second blower fan 42 may blow outdoor air to the condenser 32 to increase heat exchange between the refrigerant and outdoor air.

The second blower fan 42 may generate an air flow to allow outdoor air to be drawn into the outdoor air circulation inlet 112, and to pass through the condenser 32, and then to be discharged to the second outlet 132.

The second blower fan 42 may be disposed between the outdoor air circulation inlet 112 and the second outlet 132.

The second blower fan 42 may be operated according to the operating mode of the air conditioner 1. The second blower fan 42 may be operated in an on-state when the air conditioner 1 is in the dehumidification mode and/or temperature control mode.

The blower fan 40 may include a third blower fan 43. The third blower fan 43 may generate an air flow to allow indoor air to be drawn into the indoor air ventilation inlet 121, and to pass through the total heat exchanger 20, and then to be discharged to the third outlet 133.

The third blower fan 43 may be disposed between the indoor air ventilation inlet 121 and the third outlet 133. The third blower fan 43 may be disposed between the total heat exchanger 20 and the third outlet 133.

The third blower fan 43 may be operated according to the operating mode of the air conditioner 1. The third blower fan 43 may be operated in the on-state when the air conditioner 1 is in an indoor-outdoor air ventilation mode. A detailed description of the operation of the blower fan 40 will be described later herein.

The air conditioner 1 may include a filter 50. The filter 50 may be disposed inside the housing 10 to collect foreign substances in the air.

The filter 50 may be a High Efficiency Particulate Air (HEPA) filter. The HEPA filter may be composed of glass fibers.

The filter 50 may be provided as a photocatalyst filter that induces chemical reactions in air using a photocatalyst. In other words, the photocatalyst filter may collect various pathogens and bacteria existing in the air by the light energy of the photocatalyst. By promoting chemical action, odor particles in the air may be decomposed, removed, or collected.

However, the present disclosure is not limited thereto, and the filter 50 may be provided with various types of filters capable of collecting foreign substances.

The filter 50 may include a first filter 51 configured to filter air drawn into the first outdoor air ventilation inlet 111a, and a second filter 52 configured to filter air drawn into the second outdoor air ventilation inlet 111b.

The filter 50 may include a dust collection filter 53 configured to filter air drawn into the first outdoor air ventilation inlet 111a. The dust collection filter 53 may be configured to collect foreign substances using an electric field. The dust collection filter 53 may be configured to secondarily filter the air passing through the first filter 51.

The filter 50 may include a clean filter 54. The clean filter 54 may be configured to filter air drawn into the first outdoor air ventilation inlet 111a, the second outdoor air ventilation inlet 111b, and the indoor air circulation inlet 122. The clean filter 54 may be configured to filter air discharged through the first outlet 131.

However, the present disclosure is not limited thereto, and the filter 50 may be disposed in various positions.

The air conditioner 1 may include the partition 60. The partition 60 may be provided to prevent air inside the housing 10 from being mixed with each other. The partition 60 may be disposed between the first outlet 131 and the second outlet 132. The partition 60 may be provided to prevent air discharged through the first outlet 131 and air discharged through the second outlet 132 from being mixed with each other.

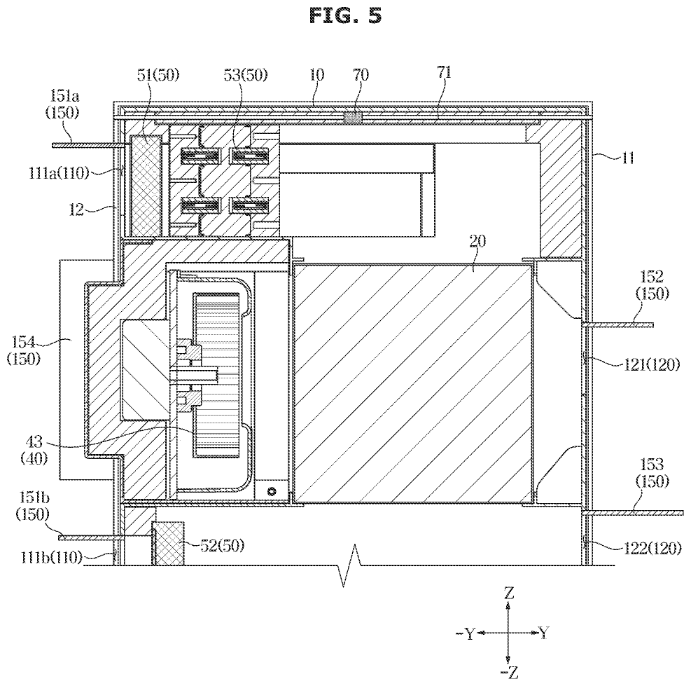

FIG. 5 is an enlarged cross-sectional view of the air conditioner according to one or more embodiments of the present disclosure.

The air conditioner 1 may include a differential pressure sensor 70. The differential pressure sensor 70 may be configured to measure an outdoor air pressure and/or an indoor air pressure.

The differential pressure sensor 70 may be disposed inside the housing 10. In order to measure the indoor and outdoor air pressure, the differential pressure sensor 70 may be disposed on a pipe 71 provided to penetrate the housing 10. The pipe 71 may be formed to penetrate the rear cover 12 and the front cover 11. However, the present disclosure is not limited thereto.

The air conditioner 1 may obtain information related to the outdoor air pressure and indoor air pressure from the differential pressure sensor 70 and control the operation of the damper 150 accordingly. The air conditioner 1 may obtain information related to the outdoor air pressure and indoor air pressure from the differential pressure sensor 70 and control the operation of the blower fan 40 accordingly. A detailed description will be provided later.

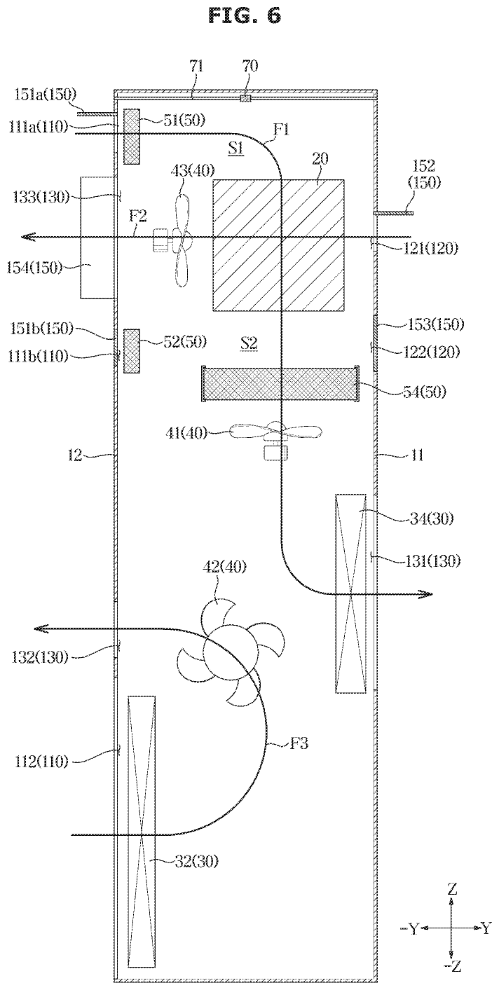

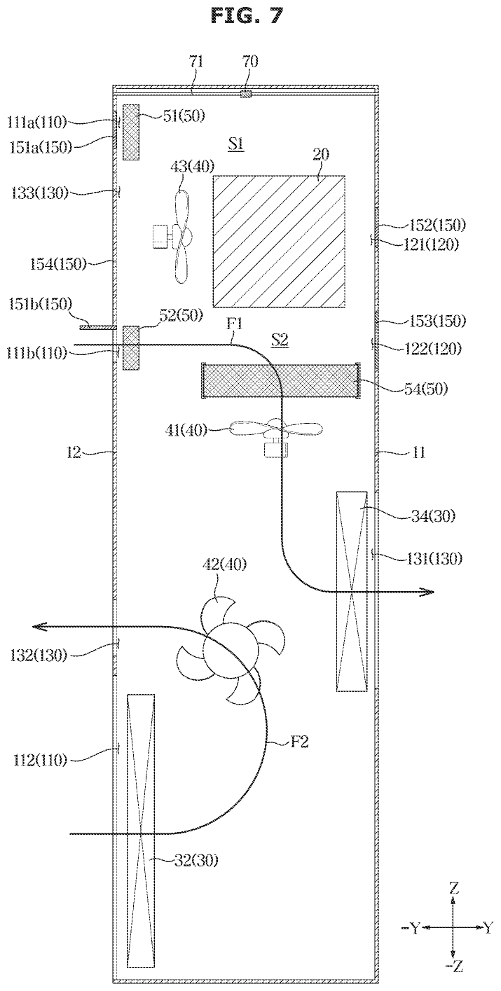

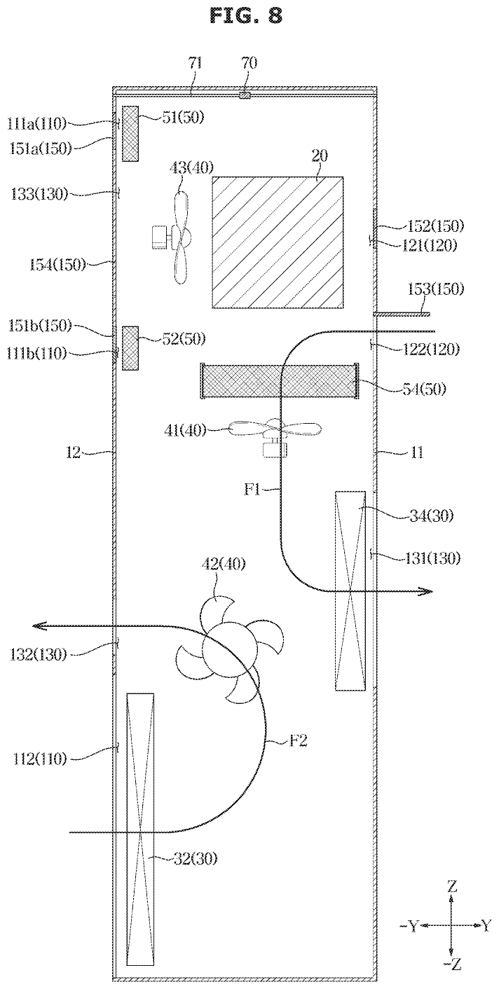

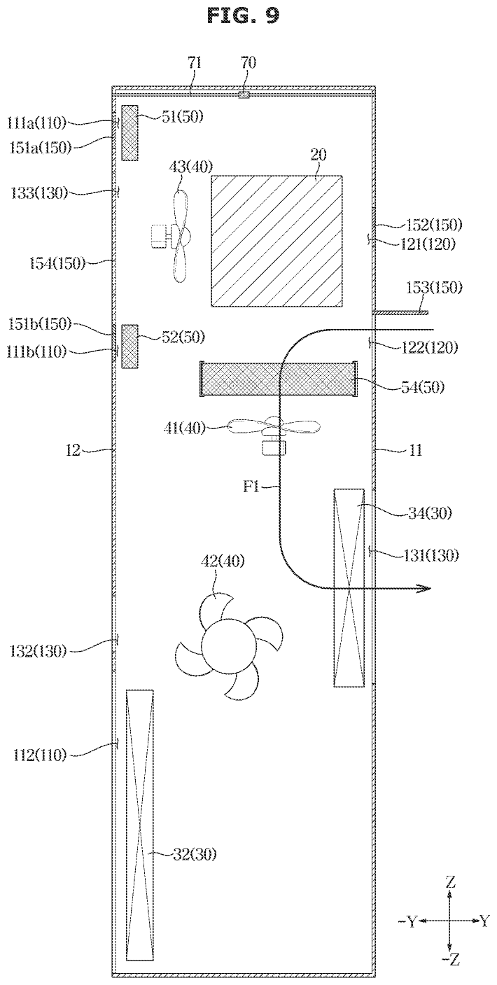

FIG. 6 is a view schematically illustrating an air flow of the air conditioner according to one or more embodiments of the present disclosure. FIG. 7 is a view schematically illustrating an air flow of the air conditioner according to one or more embodiments of the present disclosure. FIG. 8 is a view schematically illustrating an air flow of the air conditioner according to one or more embodiments of the present disclosure. FIG. 9 is a view schematically illustrating an air flow of the air conditioner according to one or more embodiments of the present disclosure.

The air conditioner 1 may be arranged in such a way that the rear cover 12 faces the outdoors and the front cover 11 faces the indoors. Based on the drawing, −Y-axis direction may be a direction toward the outdoors and +Y-axis direction may be a direction toward the indoors.

FIG. 6 illustrates an air flow when the air conditioner 1 operates in the total heat ventilation mode. A user can select the total heat ventilation mode when the user wants to ventilate indoor and outdoor air.

In the total heat ventilation mode of the air conditioner 1, the first outdoor air ventilation inlet damper 151a may open the first outdoor air ventilation inlet 111a, and the second outdoor air ventilation inlet damper 151b may close the second outdoor air ventilation inlet 111b.

In the total heat ventilation mode of the air conditioner 1, the indoor air ventilation inlet damper 152 may open the indoor air ventilation inlet 121, and the indoor air circulation inlet damper 153 may close the indoor air circulation inlet 122.

In the total heat ventilation mode of the air conditioner 1, the third outlet damper 154 may open the third outlet 133.

The first outdoor air ventilation inlet 111a may be disposed upstream of the total heat exchanger 20. The first outdoor air ventilation inlet 111a may be provided to draw in outdoor air into a first space S1 formed upstream of the total heat exchanger 20.

The first blower fan 41 may generate an air flow while being rotated by a fan motor. As a result, outdoor air may be drawn into the first outdoor air ventilation inlet 111a, pass through the total heat exchanger 20, and then be discharged to the first outlet 131 by passing through the clean filter 54 and the evaporator 34 (F1).

The third blower fan 43 may generate an air flow while being rotated by a fan motor. As a result, indoor air may be drawn into the indoor air ventilation inlet 121, pass through the total heat exchanger 20, and be discharged through the third outlet 133 (F2).

In winter, outdoor air drawn into the housing 10 through the first outdoor air ventilation inlet 111a may have a relatively low temperature, and indoor air drawn into the housing 10 through the indoor air ventilation inlet 121 may have a relatively high temperature. At this time, the outdoor air may be heated through the heat exchange with the indoor air in the total heat exchanger 20 and then discharged to the indoors through the first outlet 131.

Conversely, in summer, outdoor air drawn into the housing 10 through the first outdoor air ventilation inlet 111a may have a relatively high temperature, and indoor air drawn into the housing 10 through the indoor air ventilation inlet 121 may have a relatively low temperature. At this time, the outdoor air may be cooled through the heat exchange with the indoor air in the total heat exchanger 20 and then discharged to the indoors through the first outlet 131.

That is, by allowing the outdoor air and indoor air to pass through the total heat exchanger 20 when ventilating the outdoor air and the indoor air, it is possible to reduce the loss of indoor heating or cooling energy.

The humidity and/or temperature of the air may also be adjusted in the total heat ventilation mode of the air conditioner 1.

For example, a user can set a desired humidity and/or temperature of air, and the heat pump device 30 may operate accordingly. Particularly, the evaporator 34 may remove moisture or lower the temperature of the air passing through the total heat exchanger 20. The air may exchange heat with the evaporator 34 and be discharged to the indoors through the first outlet 131.

At this time, the second blower fan 42 may generate an air flow while being rotated by a fan motor. As a result, outdoor air may be drawn into the outdoor air circulation inlet 112, exchange heat with the condenser 32, and be discharged to the outdoors through the second outlet 132 (F3).

Because the air conditioner 1 includes both the total heat exchanger 20 and the heat pump device 30, the air conditioner 1 may perform the ventilation, cooling, heating, and dehumidification functions at the same time. As a result, the user convenience may be increased.

In addition, because the condenser 32, the compressor 31, the expansion device 33, and the evaporator 34 are disposed together inside the housing 10 of the air conditioner 1, the indoor and outdoor units may be integrated and the space utilization may be improved.

The air conditioner 1 may control the damper 150 and/or the blower fan 40 based on information obtained from the differential pressure sensor 70.

For example, when the outdoor air pressure is greater than the indoor air pressure, the air conditioner 1 may allow the first outdoor air ventilation inlet damper 151a to close at least a portion of the first outdoor air ventilation inlet 111a, and allow the third blower fan 43 to increase a rotation speed thereof. Therefore, the air conditioner 1 may allow an air volume of outdoor air drawn into the housing 10 and an air volume of indoor air discharged to the outside of the housing 10 to be substantially same. Therefore, the ventilation may be smoothly performed.

Particularly, the first outdoor air ventilation inlet damper 151a may be controlled to close at least a portion of the first outdoor air ventilation inlet 111a. For example, the first outdoor air ventilation inlet damper 151a may close the first outdoor air ventilation inlet 111a by approximately 20 to 50%. However, the present disclosure is not limited thereto.

Accordingly, by reducing the amount of outdoor air drawn into the housing 10, the ventilation of outdoor air and indoor air may be smoothly performed.

Additionally, the third blower fan 43 may be controlled to increase the rotation speed thereof. For example, the rotation speed of the third blower fan 43 may be increased by approximately 10 to 50%. However, the present disclosure is not limited thereto.

Accordingly, by increasing the amount of indoor air discharged to the outside of the housing 10, the ventilation of outdoor air and indoor air may be smoothly performed.

Conversely, when the indoor air pressure is greater than the outdoor air pressure, the air conditioner 1 may allow the indoor air ventilation inlet damper 152 to close at least a portion of the indoor air ventilation inlet 121, and to allow the first blower fan 41 to increase a rotation speed thereof. Therefore, the air conditioner 1 may allow an air volume of outdoor air drawn into the housing 10 and an air volume of indoor air discharged to the outside of the housing 10 to be substantially same. Therefore, the ventilation may be smoothly performed.

Particularly, the indoor air ventilation inlet damper 152 may be controlled to close at least a portion of the indoor air ventilation inlet 121. For example, the indoor air ventilation inlet damper 152 may close the indoor air ventilation inlet 121 by approximately 20 to 50%. However, the present disclosure is not limited thereto.

Accordingly, by reducing the amount of indoor air discharged to the outside of the housing 10, the ventilation of outdoor air and indoor air may be smoothly performed.

Additionally, the first blower fan 41 may be controlled to increase the rotation speed thereof. For example, the rotation speed of the first blower fan 41 may be increased by approximately 10 to 50%. However, the present disclosure is not limited thereto.

Accordingly, by increasing the amount of outdoor air drawn into the housing 10, the ventilation of outdoor air and indoor air may be smoothly performed.

FIG. 7 illustrates an air flow when the air conditioner 1 operates in an outdoor air introduction mode. When a user wants to introduce outdoor air, the user can select the outdoor air introduction mode. In spring or fall, the air conditioner 1 may introduce cool outdoor air into the indoors in the outdoor air introduction mode.

In the outdoor air introduction mode of the air conditioner 1, the first outdoor air ventilation inlet damper 151a may close the first outdoor air ventilation inlet 111a, and the second outdoor air ventilation inlet damper 151b may open the second outdoor air ventilation inlet 111b.

In the outdoor air introduction mode of the air conditioner 1, the indoor air ventilation inlet damper 152 may close the indoor air ventilation inlet 121, and the indoor air circulation inlet damper 153 may close the indoor air circulation inlet 122.

In the outdoor air introduction mode of the air conditioner 1, the third outlet damper 154 may close the third outlet 133.

The second outdoor air ventilation inlet 111b may be disposed downstream of the total heat exchanger 20. The second outdoor air ventilation inlet 111b may be provided to draw in outdoor air into a second space S2 formed downstream of the total heat exchanger 20.

The first blower fan 41 may generate an air flow while being rotated by the fan motor. As a result, outdoor air may be drawn through the second outdoor air ventilation inlet 111b and discharged through the first outlet 131 (F1).

That is, in the outdoor air introduction mode, the first outdoor air ventilation inlet 111a may be closed and the second outdoor air ventilation inlet 111b may be open. Accordingly, when the first blower fan 41 operates, outdoor air may be drawn through the second outdoor air ventilation inlet 111b. The air drawn into the second outdoor air ventilation inlet 111b may not pass through the total heat exchanger 20, but may directly pass through the clean filter 54 and the evaporator 34 and then be discharged through the first outlet 131.

Because the air drawn into the second outdoor air ventilation inlet 111b does not pass through the total heat exchanger 20, the rotational load of the first blower fan 41 may be reduced and thus energy efficiency may be increased. Particularly, a suction power of the first blower fan 41 for discharging the air, which is drawn through the second outdoor air ventilation inlet 111b, to the first outlet 131 may be less than a suction power of the first blower fan 41 for discharging the air, which is drawn through the first outdoor air ventilation inlet 111a, to the first outlet 131. Accordingly, the efficiency may be increased.

The third blower fan 43 may be in a stopped state. Accordingly, indoor air may not be drawn into the indoor air ventilation inlet 121.

Because the indoor air ventilation inlet 121 and the indoor air circulation inlet 122 are in the closed state, indoor air may not be drawn into the housing 10. That is, in the outdoor air introduction mode, only outdoor air may be introduced without discharging indoor air.

The humidity and/or temperature of the air may also be adjusted in the outdoor air introduction mode of the air conditioner 1. A user can set the desired air humidity and/or temperature, and the heat pump device 30 may operate accordingly. As a result, outdoor air may be drawn into the outdoor air circulation inlet 112, exchange heat with the condenser 32, and be discharged to the outdoors through the second outlet 132 (F2).

The air drawn into the second outdoor air ventilation inlet 111b may exchange heat with the evaporator 34 and be discharged to the indoors through the first outlet 131 (F1). A description the same as FIG. 6 will be omitted.

FIG. 8 and FIG. 9 illustrate an air flow when the air conditioner 1 operates in an internal circulation mode. A user can select the internal circulation mode when the user only wants to circulate indoor air without introducing outdoor air. That is, when the ventilation is not required, the user can select the internal circulation mode.

In the internal circulation mode of the air conditioner 1, the first outdoor air ventilation inlet damper 151a may close the first outdoor air ventilation inlet 111a, and the second outdoor air ventilation inlet damper 151b may close the second outdoor air ventilation inlet 111b.

In the internal circulation mode of the air conditioner 1, the indoor air ventilation inlet damper 152 may close the indoor air ventilation inlet 121, and the indoor air circulation inlet damper 153 may open the indoor air circulation inlet 122.

In the internal circulation mode of the air conditioner 1, the third outlet damper 154 may close the third outlet 133.

The first blower fan 41 may generate an air flow while being rotated by the fan motor. As a result, indoor air may be drawn into the indoor air circulation inlet 122 and discharged through the first outlet 131 (F1).

That is, in the internal circulation mode, the first blower fan 41 may operate and the third blower fan 43 may be stopped. Accordingly, indoor air may be drawn into the indoor air circulation inlet 122 and discharged through the first outlet 131.

Additionally, in the internal circulation mode, the indoor air ventilation inlet 121 may be closed and the indoor air circulation inlet 122 may be open. Accordingly, indoor air may be drawn into the indoor air circulation inlet 122.

In the internal circulation mode of the air conditioner 1, the humidity and/or temperature of the air may be adjusted together.

For example, a user can set a desired humidity and/or temperature of air, and the heat pump device 30 may operate accordingly. The air drawn into the indoor air circulation inlet 122 may exchange heat with the evaporator 34 and be discharged to the indoors through the first outlet 131.

At this time, outdoor air may be drawn into the outdoor air circulation inlet 112, exchange heat with the condenser 32, and discharged to the outdoors through the second outlet 132 (F2). A description the same as FIG. 6 and FIG. 7 will be omitted.

Referring to FIG. 9, the air conditioner 1 may only perform an air purification function in the internal circulation mode. At this time, the heat pump device 30 may not operate, and the air drawn into the indoor air ventilation inlet 121 may pass through the clean filter 54 and be discharged through the first outlet 131 (F1). At this time, the second blower fan 42 may be in the stopped state.

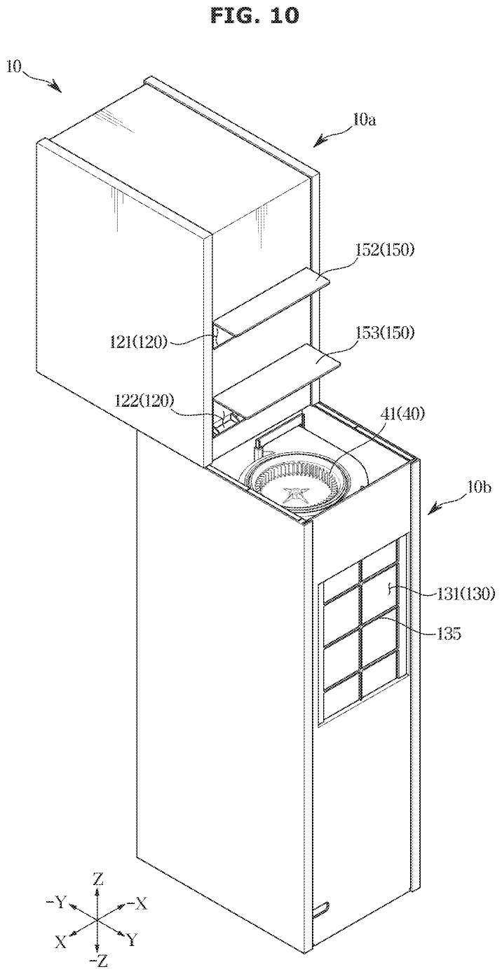

FIG. 10 is a perspective view illustrating a state in which the air conditioner according to one or more embodiments of the present disclosure is divided.

The housing 10 may include an upper housing 10a and a lower housing 10b. The lower housing 10b may be removably coupled to a lower portion of the upper housing 10a.

The lower housing 10b may be slidably separated from the upper housing 10a toward the front. The lower housing 10b may be provided to be movable toward the indoor space.

Components such as the total heat exchanger 20 and the clean filter 54 may be disposed in the upper housing 10a. Components such as the first blower fan 41, the second blower fan 42, and the heat pump device 30 may be disposed in the lower housing 10b.

It is possible to replace the clean filter 54 by withdrawing the clean filter 54 toward the indoors through the indoor air circulation inlet 122 formed in the upper housing 10a. Therefore, it is possible to easily clean and replace the clean filter 54.

Because the lower housing 10b moves toward the indoors, the components disposed inside the lower housing 10b may be easily serviced as the components are withdrawn into the indoors. For example, maintenance of the heat pump device 30 disposed inside the lower housing 10b may be facilitated.

However, the present disclosure is not limited thereto, and the upper housing 10a and the lower housing 10b may be integrally formed with each other.

FIG. 11 is a view illustrating a state in which the air conditioner according to one or more embodiments of the present disclosure is installed. FIG. 12 is a view illustrating a state in which the air conditioner according to one or more embodiments of the present disclosure is installed.

The air conditioner 1 may be installed in the window 2. The air conditioner 1 may be arranged in such a way that the front cover 11 faces the indoors and the rear cover 12 faces the outdoors with the window 2 interposed therebetween. However, the present disclosure is not limited thereto, and a space in which the air conditioner 1 is installed may vary.

The air conditioner 1 may perform both indoor and outdoor air ventilation and air humidity and temperature control functions, thereby increasing the user convenience. Additionally, the space utilization may be increased by integrating the configuration of the indoor and outdoor units.

The embodiment of FIG. 10 may be combined with the embodiment of FIG. 1, FIG. 2, FIG. 3, FIG. 4, FIG. 5, FIG. 6, FIG. 7, FIG. 8, FIG. 9, FIG. 10, FIG. 11, and FIG. 12.

The air conditioner 1 according to one or more embodiments may include the housing 10 including the outdoor air inlet 110 provided to draw in outdoor air, the indoor air inlet 120 provided to draw in indoor air, and the outlet 130 provided to discharge air introduced into the outdoor air inlet 110 and the indoor air inlet 120, the blower fan 40 disposed in the housing 10 and configured to generate an air flow, the total heat exchanger 20 disposed in the housing 10 and configured to exchange heat between air drawn through the outdoor air inlet and air drawn through the indoor air inlet, the compressor 31 disposed inside the housing 10 to compress a refrigerant, the condenser 32 configured to condense the refrigerant compressed by the compressor 31, the expansion device 33 configured to expand the refrigerant condensed in the condenser 32, and the evaporator 34 configured to evaporate the refrigerant discharged from the expansion device 33. The outlet 130 may include the first outlet 131 provided to discharge air, which passes through the total heat exchanger 20 and the evaporator 34, into the indoors, and the second outlet 132 provided to discharge air, which passes through the condenser 32, to the outdoors. According to the present disclosure, the air conditioner 1 may ventilate indoor air and outdoor air and simultaneously control the humidity and temperature of the air. In addition, the space utilization may be increased as the indoor and outdoor units are integrated.

The outdoor air inlet 110 may include the outdoor air ventilation inlet 111 provided to allow outdoor air to move into the outdoor air ventilation flow path discharged to the first outlet 131, and the outdoor air circulation inlet 112 provided to allow outdoor air to move into the outdoor air circulation flow path discharged to the second outlet 132, and spaced apart from the outdoor air ventilation inlet 111. According to the present disclosure, the air conditioner 1 may simultaneously perform the ventilation function and the temperature and humidity control function. In addition, the air conditioner 1 may simultaneously perform the function of an outdoor unit by including the outdoor air circulation inlet 112 provided to pass through the condenser 32.

The outdoor air ventilation flow path may include the first space S1 formed upstream of the total heat exchanger 20 and the second space S2 formed downstream of the total heat exchanger 20. The outdoor air ventilation inlet 111 may include the first outdoor air ventilation inlet 111a provided to draw in outdoor air into the first space S1, and the second outdoor air ventilation inlet 111b provided to draw in outdoor air into the second space S2. According to the present disclosure, the second outdoor air ventilation inlet 111b may be arranged to prevent air from passing through the total heat exchanger 20, thereby reducing the load on the blower fan 40 so as to increase the energy efficiency.

The air conditioner 1 may further include the first outdoor air ventilation inlet damper 151a configured to open and close the first outdoor air ventilation inlet 111a, and the second outdoor air ventilation inlet damper 151b configured to open and close the second outdoor air ventilation inlet 111b. According to the present disclosure, by selectively opening and closing the first outdoor air ventilation inlet damper 151a and the second outdoor air ventilation inlet damper 151b, it is possible to change the inlet flow path of the outdoor air according to the mode of the air conditioner 1.

The blower fan 40 may include the first blower fan 41 configured to generate an air flow to discharge air, which is drawn into the outdoor air ventilation inlet 111, to the first outlet 131, and the second blower fan 42 configured to generate an air flow to discharge air, which is drawn into the outdoor air circulation inlet 112, to the second outlet 132. According to the present disclosure, the air conditioner 1 may simultaneously perform not only the ventilation function but also the temperature and humidity control function.

The outlet 130 may further include the third outlet 133 provided to discharge air, which is drawn into the indoor air inlet 120 and passes through the total heat exchanger 20, to the outside of the housing 10. The indoor air inlet 120 may include the indoor air circulation inlet 122 provided to allow indoor air to move into the indoor air circulation flow path discharged to the first outlet 131, and the indoor air ventilation inlet 121 provided to allow indoor air to move into the indoor air ventilation flow path discharged to the third outlet 133, and spaced apart from the indoor air circulation inlet 122. The blower fan 40 may further include the third blower fan 43 configured to generate an air flow to discharge air, which is drawn into the indoor air ventilation inlet 121, to the third outlet 133. According to the present disclosure, the air conditioner 1 may efficiently perform the ventilation by discharging indoor air to the outside.

The air conditioner 1 may further include the indoor air circulation inlet damper 153 configured to open and close the indoor air circulation inlet 122, and the indoor air ventilation inlet damper 152 configured to open and close the indoor air ventilation inlet 121. According to the present disclosure, by selectively opening and closing the indoor air circulation inlet damper 153 and the indoor air ventilation inlet damper 152, it is possible to change the inlet flow path of the indoor air according to the mode of the air conditioner 1.

The air conditioner 1 may further include the differential pressure sensor 70 configured to measure an outdoor air pressure and an indoor air pressure, and the processor electrically connected to the differential pressure sensor 70, the first outdoor air ventilation inlet damper 151a, the indoor air ventilation inlet damper 152, the first blower fan 41, and the third blower fan 43. According to the present disclosure, the air conditioner 1 may measure the outdoor air pressure and indoor air pressure from the differential pressure sensor 70 and change the intake amount of outdoor air and indoor air.

The processor may be configured to obtain information related to an outdoor air pressure and an indoor air pressure from the differential pressure sensor 70. In response to the outdoor air pressure being greater than the indoor air pressure, the processor may be configured to allow the first outdoor air ventilation inlet damper 151a to close at least a portion of the first outdoor air ventilation inlet 111a, and configured to allow the third blower fan 43 to increase the rotation speed thereof. According to the present disclosure, when the outdoor air pressure is greater than the indoor air pressure, it is possible to reduce the amount of outdoor air drawn into the housing 10 and to increase the amount of indoor air drawn into the housing 10. Therefore, it is possible to adjust the amount of indoor air and outdoor air drawn into the housing 10 and thus the air may be smoothly ventilated.

The processor may be configured to obtain information related to an outdoor air pressure and an indoor air pressure from the differential pressure sensor 70. In response to the indoor air pressure being greater than the outdoor air pressure, the processor may be configured to allow the indoor air ventilation inlet damper 152 to close at least a portion of the indoor air ventilation inlet 121 and configured to allow the first blower fan 41 to increase the rotation speed thereof. According to the present disclosure, when the indoor air pressure is greater than the outdoor air pressure, it is possible to reduce the amount of indoor air drawn into the housing 10 and to increase the amount of outdoor air drawn into the housing 10. Therefore, it is possible to adjust the amount of indoor air and outdoor air drawn into the housing 10 and thus the air may be smoothly ventilated.

The housing 10 may include the upper housing 10a and the lower housing 10b removably coupled to the upper housing. The compressor 31, the condenser 32, the expansion device 33, and the evaporator 34 may be disposed in the lower housing 10b. The total heat exchanger 20 may be disposed in the upper housing 10a. According to the present disclosure, the heat pump device 30 of the air conditioner 1 may be disposed in the lower housing 10b and may be separated. Accordingly, the accessibility from the indoors may be facilitated, and thus service for repair and replacement of components may be facilitated.

The air conditioner 1 may further include the partition 60 disposed between the first outlet 131 and the second outlet 132 to prevent the air inside the housing 10 from being mixed with each other. According to the present disclosure, it is possible to separate the air flow path inside the housing 10, thereby preventing air from being mixed with each other.

The air conditioner 1 according to one or more embodiments may include the housing 10 including the outdoor air inlet 110 provided to draw in outdoor air, the indoor air inlet 120 provided to draw in indoor air, and the outlet 130 provided to discharge air introduced into the outdoor air inlet 110 and the indoor air inlet 120, the damper 150 configured to open and close the outdoor air inlet 110, the blower fan 40 disposed in the housing 10 and configured to generate an air flow, the total heat exchanger 20 disposed in the housing 10 and configured to exchange heat between air drawn through the outdoor air inlet 110 and air drawn through the indoor air inlet 120, the compressor 31 disposed inside the housing 10 to compress a refrigerant, the condenser 32 configured to condense the refrigerant compressed by the compressor 31, the expansion device 33 configured to expand the refrigerant condensed in the condenser 32, and the evaporator 34 configured to evaporate the refrigerant discharged from the expansion device 33. The outdoor air inlet 110 may include the first outdoor air ventilation inlet 111a provided to draw in outdoor air into the first space S1 formed upstream of the total heat exchanger 20 to exchange heat with air drawn through the indoor air inlet 120, and the second outdoor air ventilation inlet 111b provided to draw in outdoor air into the second space S2 formed downstream of the total heat exchanger 20. The damper 150 may include the first outdoor air ventilation inlet damper 151a configured to open and close the first outdoor air ventilation inlet 111a, and the second outdoor air ventilation inlet damper 151b configured to open and close the second outdoor air ventilation inlet 111b in response to the first outdoor air ventilation inlet 111a being opened by the first outdoor air ventilation inlet damper 151a. According to the present disclosure, the air conditioner 1 may ventilate indoor air and outdoor air and simultaneously control the humidity and temperature of the air. In addition, the space utilization may be increased by integrating the indoor and outdoor units. Additionally, by selectively opening and closing the first outdoor air ventilation inlet damper 151a and the second outdoor air ventilation inlet damper 151b, it is possible to change the inlet flow path of the outdoor air according to the mode of the air conditioner 1.

The outlet 130 may include the first outlet 131 provided to discharge air, which passes through the total heat exchanger 20 and the evaporator 34, to the outside of the housing 10, the second outlet 132 provided to discharge air, which passes through the condenser 32, to the outside of the housing 10, and the third outlet 133 provided to discharge air, which is drawn into the indoor air inlet 120 and passes through the total heat exchanger 20, to the outside of the housing 10. The indoor air inlet 120 may include the indoor air circulation inlet 122 provided to allow indoor air to move into the indoor air circulation flow path discharged to the first outlet 131, and the indoor air ventilation inlet 121 provided to allow indoor air to move into the indoor air ventilation flow path discharged to the third outlet 133, and spaced apart from the indoor air circulation inlet 122. According to the present disclosure, the air conditioner 1 may efficiently perform the ventilation by discharging indoor air to the outside.

The air conditioner 1 may further include the differential pressure sensor 70 configured to measure an outdoor air pressure and an indoor air pressure, and the processor electrically connected to the differential pressure sensor 70, and the first outdoor air ventilation inlet damper 151a. The processor may be configured to obtain information related to an outdoor air pressure and an indoor air pressure from the differential pressure sensor 70. In response to the outdoor air pressure being greater than the indoor air pressure, the processor may be configured to allow the first outdoor air ventilation inlet damper 151a to close at least a portion of the first outdoor air ventilation inlet 111a. According to the present disclosure, the air conditioner 1 may measure the outdoor air pressure and indoor air pressure from the differential pressure sensor 70 and change the intake amount of outdoor air and indoor air.

The air conditioner 1 according to one embodiment may be configured to be installed on the window 2. The air conditioner 1 may include the housing 10 including the outdoor air inlet 110 provided to open toward the outdoors, the indoor air inlet 120 provided to open toward the indoors, the first outlet 131 provided to open toward the outdoors, and the second outlet 132 provided to open toward the indoors, the total heat exchanger 20 disposed in the housing 10 and configured to exchange heat between air drawn through the outdoor air inlet 110 and air drawn through the indoor air inlet 120, the compressor 31 disposed inside the housing 10 to compress a refrigerant, the condenser 32 configured to condense the refrigerant compressed by the compressor 31, the expansion device 33 configured to expand the refrigerant condensed in the condenser 32, the evaporator 34 configured to evaporate the refrigerant discharged from the expansion device 33, and the blower fan 40 disposed inside the housing 10. The blower fan 40 may include the first blower fan 41 configured to generate an air flow to allow air, which is drawn into the outdoor air inlet 110 and the indoor air inlet 120, to pass through the evaporator 34 and then to be discharged to the first outlet 131, and the second blower fan 42 configured to generate an air flow to allow air, which is drawn into the outdoor air inlet 110, to pass through the condenser 32 and then to be discharged to the second outlet 132. According to the present disclosure, the air conditioner 1 may ventilate indoor air and outdoor air and simultaneously control the humidity and temperature of the air. In addition, the space utilization may be increased by integrating the indoor and outdoor units.

As is apparent from the above description, an air conditioner may perform a ventilation function.

Further, an air conditioner may control humidity and temperature of air.

Further, the space utilization of an air conditioner may be increased.

Further, the energy efficiency of an air conditioner may be increased.

Additional aspects of the disclosure will be set forth in part in the description which follows and, in part, will be obvious from the description, or may be learned by practice of the disclosure.

While example embodiments of the present disclosure have been particularly described and shown, it should be understood by those of skilled in the art that various changes in form and details may be made without departing from the spirit and scope of the present disclosure.

What is claimed is:

1. An air conditioner comprising:
a housing comprising:
an outdoor air inlet configured to draw in outdoor air;
an indoor air inlet configured to draw in indoor air; and
an outlet configured to discharge air introduced into the outdoor air inlet and the indoor air inlet;
a blower fan in the housing and configured to generate an air flow;
a total heat exchanger in the housing and configured to exchange heat between the outdoor air drawn through the outdoor air inlet and the indoor air drawn through the indoor air inlet;
a compressor in the housing and configured to compress a refrigerant;
a condenser configured to condense the refrigerant as compressed by the compressor;
an expansion device configured to expand the refrigerant as condensed in the condenser; and
an evaporator configured to evaporate the refrigerant as discharged from the expansion device,
wherein the outlet comprises:
a first outlet configured to discharge the outdoor air, which passes through the total heat exchanger and the evaporator, into an indoors; and
a second outlet configured to discharge the indoor air, which passes through the condenser, to the outdoors.

2. The air conditioner of claim 1, wherein the outdoor air inlet comprises:
an outdoor air ventilation inlet configured to pass the outdoor air into an outdoor air ventilation flow path discharged to the first outlet; and
an outdoor air circulation inlet configured to pass the outdoor into an outdoor air circulation flow path discharged to the second outlet, and
wherein the outdoor air circulation inlet is spaced apart from the outdoor air ventilation inlet.

3. The air conditioner of claim 2, wherein the outdoor air ventilation flow path comprises a first space formed upstream of the total heat exchanger, and a second space formed downstream of the total heat exchanger,
wherein the outdoor air ventilation inlet comprises:
a first outdoor air ventilation inlet configured to draw in the outdoor air into the first space; and
a second outdoor air ventilation inlet configured to draw in the outdoor air into the second space.

4. The air conditioner of claim 3, further comprising:
a first outdoor air ventilation inlet damper configured to open and close the first outdoor air ventilation inlet; and
a second outdoor air ventilation inlet damper configured to open and close the second outdoor air ventilation inlet.

5. The air conditioner of claim 4, wherein the blower fan comprises:
a first blower fan configured to generate an air flow to discharge the outdoor air, which is drawn into the outdoor air ventilation inlet, to the first outlet; and
a second blower fan configured to generate an air flow to discharge the outdoor air, which is drawn into the outdoor air circulation inlet, to the second outlet.

6. The air conditioner of claim 5, wherein the outlet further comprises a third outlet configured to discharge the indoor air, which is drawn into the indoor air inlet and passes through the total heat exchanger, to the outdoors.

7. The air conditioner of claim 6, wherein the indoor air inlet comprises:
an indoor air circulation inlet configured to pass the indoor air into an indoor air circulation flow path discharged to the first outlet; and
an indoor air ventilation inlet configured to pass the indoor air into an indoor air ventilation flow path discharged to the third outlet, and
wherein the indoor air ventilation inlet is spaced apart from the indoor air circulation inlet.

8. The air conditioner of claim 7, wherein the blower fan further comprises:
a third blower fan configured to generate an air flow to discharge the indoor air, which is drawn into the indoor air ventilation inlet, to the third outlet.

9. The air conditioner of claim 8, further comprising:
an indoor air circulation inlet damper configured to open and close the indoor air circulation inlet; and
an indoor air ventilation inlet damper configured to open and close the indoor air ventilation inlet.

10. The air conditioner of claim 9, further comprising:
a differential pressure sensor configured to measure an outdoor air pressure and an indoor air pressure; and
a processor electrically connected to the differential pressure sensor, the first outdoor air ventilation inlet damper, the indoor air ventilation inlet damper, the first blower fan, and the third blower fan.

11. The air conditioner of claim 10, wherein the processor is configured to:
obtain information related to the outdoor air pressure and the indoor air pressure from the differential pressure sensor, and
based on the outdoor air pressure being greater than the indoor air pressure, control the first outdoor air ventilation inlet damper to close at least a portion of the first outdoor air ventilation inlet and control the third blower fan to increase a rotation speed thereof.

12. The air conditioner of claim 10, wherein the processor is further configured to:
obtain information of the outdoor air pressure and the indoor air pressure from the differential pressure sensor, and
based on the indoor air pressure being greater than the outdoor air pressure, control the indoor air ventilation inlet damper to close at least a portion of the indoor air ventilation inlet and control the first blower fan to increase a rotation speed thereof.

13. The air conditioner of claim 1, wherein the housing comprises an upper housing and a lower housing removably coupled to the upper housing, and
wherein the compressor, the condenser, the expansion device, and the evaporator are disposed in the lower housing.

14. The air conditioner of claim 13, wherein the total heat exchanger is in the upper housing.

15. The air conditioner of claim 1, further comprising:
a partition disposed between the first outlet and the second outlet and configured to prevent mixing of air in the housing.
